(19) United States
(12) Patent Application Publication
(10) Pub. No.: US 2005/0270136 A1
(43) Pub. Date: Dec. 8, 2005

(54) Device comprising a circuit arrangement with an inductive element

(75) Inventors: Tobias Georg Tolle, Aachen (DE); Thomas Durbaum, Langerwehe (DE); Reinhold Elferich, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/521,849

(22) PCT Filed: Jul. 16, 2003
(86) PCT No.: PCT/IB03/03237

§ 371 Date: Jan. 21, 2005

(30) Foreign Application Priority Data
Jul. 26, 2002 (DE) 102 34 081.1

(51) Int. Cl. H01F 5/00

(52) U.S. Cl. 336/200

(57) ABSTRACT

The invention relates to a device which comprises a circuit arrangement and at least one inductive element. In order to form a device with a circuit arrangement with one or more inductive elements which can be manufactured as economically as possible, it is proposed to use an electrically conductive plate (13) having an inductive function, the inductive function corresponding to a structure of slits (20a, 20b, 20c) formed in the plate.

The invention relates to a device which comprises a circuit arrangement and at least one inductive element. Inductive elements such as coils come in numerous shapes and forms, for example, as windings provided on a coil former. The invention relates notably to the field of power supply devices which often utilize inductive elements which have a significant effect on the cost of manufacture.

The invention has for its object to provide a device with a circuit arrangement with one or more inductive elements which can be manufactured as economically as possible.

The object is achieved by means of an electrically conductive plate having an inductive function, which inductive function corresponds to a structure of slits formed in the plate.

Inexpensive electrically conductive plates are available, for example, as plates made of sheet metal. The structure of slits can be provided by means of a simple stamping operation, so that one or more inductive elements can be manufactured by means of a single plate element. The structure of slits, however, can also be formed, for example by milling, by laser treatment or also by etching. Furthermore, the use of a single plate for the inductive elements also allows for a flat and compact (modular) construction of the device in accordance with the invention. Furthermore, a plate of this kind is easy to handle and the number of external connections is reduced in comparison with a situation where use is made of separate coils with coil formers. The plate, however, can also be mounted separately on other parts of the device, for example, on the wall of a housing. Using plates of this kind, inductances can be formed which satisfy severe requirements as regards tolerances, that is, notably a plurality of identical inductances. Furthermore, a plate of this kind may also perform a cooling function. The magnetic coupling between the windings formed by means of the structure of slits can be readily influenced by choosing suitable distances between the windings.

The structure of slits is provided in particular in the form of one or more spiral-shaped slits. A number of coil windings which corresponds to the number of slits can thus be formed. In order to contact the coils it is proposed to provide the spiral-shaped slits with a respective contact point in their central region. Additionally, one or more contact points can be provided adjacent the spiral-shaped slits. The contact points situated outside the spiral-shaped slits are then short-circuited by the electrically conductive plate; selection of a plurality of external contact points then enables a current distribution among a plurality of contact points in order to reduce losses and to avoid overloading of individual contact points. It is also possible to provide contact points as further tapping points between the contact points situated in the central regions and the outer edges of the slits. The electrically conductive plate in accordance with the invention can also be used to form inductances merely by means of contact points provided in the central regions of the slits. In one embodiment of the invention the electrically conductive plate is arranged on a printed circuit board and electrically connected to the circuit on the printed circuit board. In order to avoid any undesirable short-circuits between the printed circuit and the electrically conductive plate, in one embodiment of the device in accordance with the invention an insulating layer is provided between the printed circuit board and the electrically conductive plate. In a further embodiment of the invention a layer of a magnetic material, notably a ferrite material is provided on at least one side of the electrically conductive plate; this results in an increased inductance of the inductive elements provided by the conductive plate while a compact construction is maintained nevertheless. A layer of a magnetic material can be used to influence the complete structure of slits and possibly a plurality of corresponding structures of slits. The use of one or more layers of a magnetic material is attractive from a manufacturing point of view and is also economical.

A preferred application of the device in accordance with the invention is its use in a power supply device (converter). The invention can be advantageously used in particular in the case of multi-phase DC/DC converters, comprising a plurality of circuit branches with each time at least one inductance, one inductance, a plurality of inductances or also all inductances then being presented by the electrically conductive plate provided with a structure of slits.

Embodiments of the invention will be described in detail hereinafter with reference to the drawings. Therein:

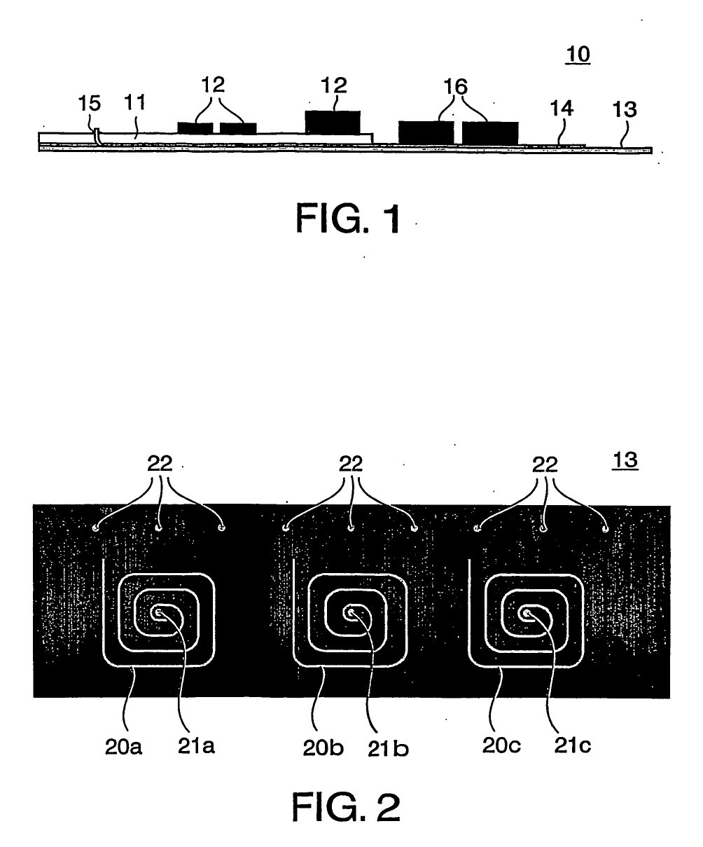

FIG. 1 shows a device in accordance with the invention,

FIG. 2 shows a plate provided with a structure of slits in accordance with the invention,

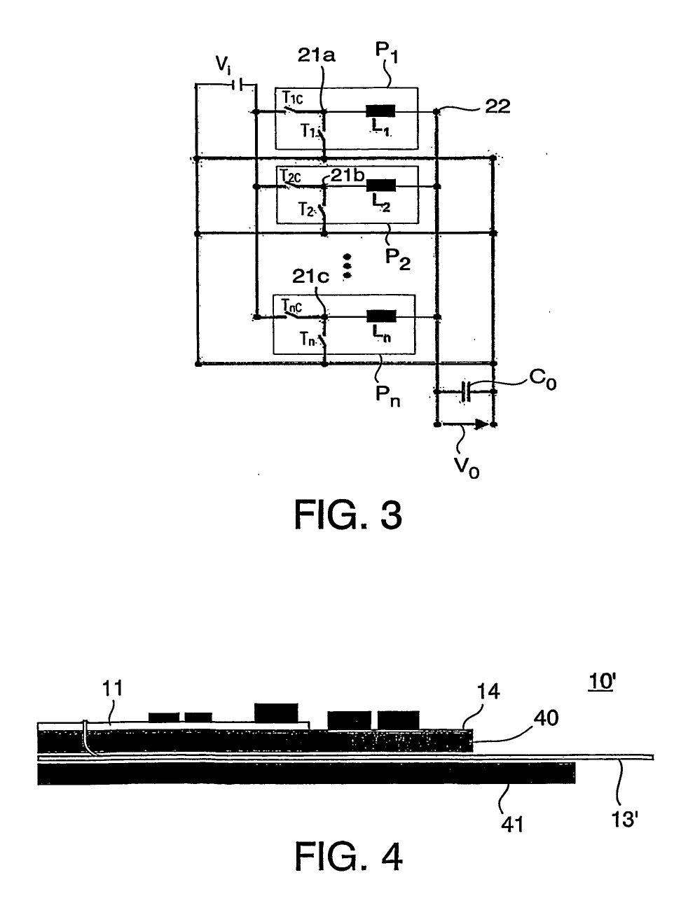

FIG. 3 shows a power supply circuit for the device in accordance with the invention,

FIG. 4 shows a device in accordance with the invention which is provided with layers of a magnetic material,

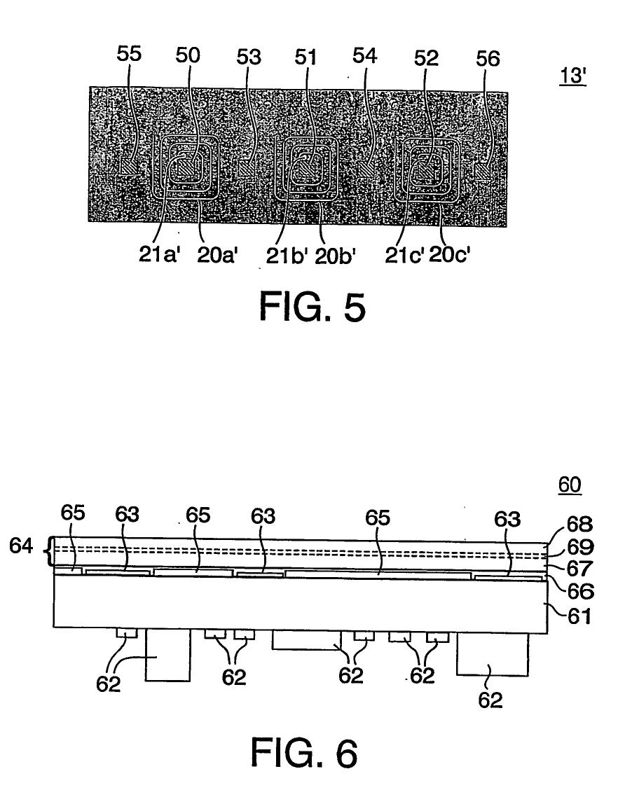

FIG. 5 shows the construction of the plate provided with a structure of slits for the device shown in FIG. 4,

FIG. 6 shows a further embodiment of the device in accordance with the invention, and

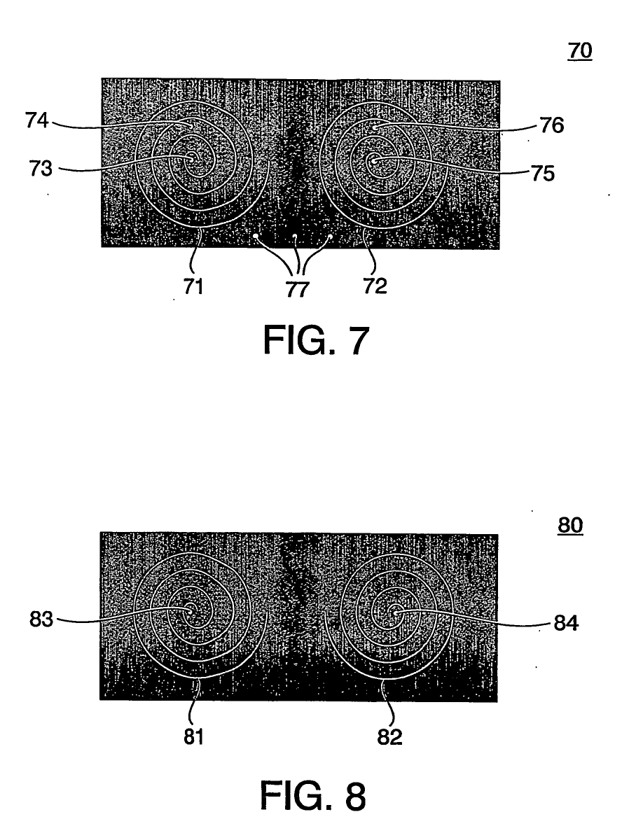

FIGS. 7 and 8 show further versions of the plate provided with a structure of slits in accordance with the invention

The device 10 shown in FIG. 1 is provided with a circuit arrangement which comprises a circuit which is arranged on a printed circuit board (PCB) 11 and further components 12 which are separately soldered thereon and are situated on the upper surface of the printed circuit board 11. On the lower side of the printed circuit board 11 there is arranged an electrically conductive plate 13, an insulating layer 14 being provided between the electrically conductive plate 13 and the printed circuit board 11, said insulating layer 14 supporting further separate components 16 of the circuit arrangement in the present embodiment. The electrically conductive plate 13 of the present embodiment is constructed as a metal plate which is provided with a structure of slits as will be described in detail hereinafter.

In this case the plate 13 consists of a copper sheet but it may also be formed, for example, as an electrically conductive layer of a multilayer printed circuit board or as an electrically conductive layer provided on an arbitrary substrate.

Connection pieces 15, only one of which is shown in FIG. 1, serve to establish electrical connections between the plate 13 and the circuit of the printed circuit board 11. The connection pieces 15 in the present embodiment are constructed as bent portions of the plate 13 which extend through cut-outs in the insulating layer 14 and the printed circuit board 11 and are soldered to the circuit of the printed circuit board 11 on the upper side of the printed circuit board (soldering on the lower side of the printed circuit board (not shown) is also possible). The plate 13 in this case serves also as a cooling member for dissipating loss heat produced by electronic components of the device 10 to the environment.

FIG. 2 is a plan view of the plate 13. It is provided with a structure of slits with three spiral-shaped slits 20a, 20b and 20c which define spiral-like windings or tracks which have the same winding orientation and provide an inductive effect as coil windings, it being readily possible to form also different winding orientations; applications involving only a single spiral-shaped slit are also feasible. In the central region of the spiral-shaped slits 20a, 20b and 20c there is provided a respective contact point 21a, 21b and 21c. Furthermore, outside (above) the slits 20a, 20b and 20c there are provided contact points 22 which are arranged in a row and are short-circuited by the plate 13. Via the contact points 21a, 21b and 21c and one of the contact points 22, the plate 13 is electrically connected to the circuit arrangement on the printed circuit board 11 via the connection pieces 15 in FIG. 1. The plate 13 in this case performs the function of three coils. A sub-structure formed by each of the slits 20a, 20b and 20c corresponds to a respective coil; this means that an inductance which corresponds to the slit 20a can be derived between the contact point 21a and the contact points 22; the same holds for the other two contact points 21b and 21c and the other slits 20b and 20c, respectively. Currents flowing into the plate 13 via the inner contact points 21a, 21b and 21c follow a spiral-shaped path and hence produce inductive effects from the respective inner contact point towards the outside and to the contact point 22 used.

FIG. 3 shows a preferred embodiment of a circuit arrangement which is realized by means of the device shown in FIG. 1 and the plate shown in FIG. 2. FIG. 3 shows a multi-phase DC/DC converter 30; this means that the device 10 of FIG. 1 constitutes a power supply device provided with such a converter circuit. The input of the converter 30 receives the input DC voltage Vᵢ which is stepped down to an output DC voltage V₀ by the converter 30. The converter 30 processes the input voltage Vᵢ in a multi-phase fashion, that is, the input voltage Vᵢ is processed in parallel by n DC step-down converters P1, P2 . . . Pn, where n=3, the outputs of which are connected parallel to an output capacitance C₀ and hence parallel to the output of the converter 30, and whose switching transistors operate in a phase-shifted fashion. The DC step-down converters comprise as usual a respective control transistor (transistors T_{1C} . . . T_{nC}), a switched rectifier (transistors T₁ . . . Tₙ) and an inductance (L₁ . . . Lₙ), the inductances being provided by coils in conventional converters. In the proposed embodiment in accordance with the invention the three inductances L₁, L₂ and L₃ are formed by means of the plate 13 provided with the structure of slits as shown in FIG. 2, the spiral-shaped slit 20a forming the inductance L₁, the slit 20b the inductance L₂ and the slit 20c the inductance L₃. The contact point 21a is then connected to the transistors T_{1C} and T₁, the contact point 21b being connected to the transistors T_{2C} and T₂ while the contact point 21c is connected to the transistors T_{3C} and T₃. A connection to the output capacitance C₀, and hence the converter output, is established by means of one of the contact points 22.

Multi-phase converters as shown in FIG. 3 are suitable in particular for power supply devices which are referred to as VRMs (voltage regulator modules) and are intended for fast processors of personal computers with a high clock frequency; in addition to a compact construction they enable in particular a fast changing of loads. The comparatively small inductances L₁ . . . Tₙ required can be formed by means of a plate provided with a structure of slits as shown in FIG. 3 and a high DC carrying capacity can be adjusted by adaptation of the thickness of the plate 13.

FIGS. 4 and 5 show a version 10′ of the device 10. Instead of arranging the plate 13 with the structure of slits directly on the lower side of the insulating layer 14 as shown in the FIGS. 1 and 2, a plate 13′ which is provided with a structure of slits consisting of three spiral-shaped slits 20a′, 20b′ and 20c′ as shown in FIG. 2 is now arranged between two layers 40 and 41 of a magnetic material (possibly at a distance and separated by further insulating layers between the plate 13′ and the layers of magnetic material in order to reduce (proximity) losses), said three layers being provided on the lower side of the insulating layer 14. Ferrite is preferably used as the magnetic material intended to increase the inductances that can be generated by means of the plate 13′. The layers of magnetic material also serve for electromagnetic shielding and for reducing interference radiation to the environment. In order to close the magnetic circuits for the inductances produced by means of the slits 20a′, 20b′ and 20c′, the plate 13′ is provided with cut-outs 50 to 56 wherethrough pieces of magnetic material project so as to conduct magnetic fluxes between the layers of magnetic material 40 and 41 and to close the relevant magnetic circuit The cut-outs 50, 51 and 52 are all provided in the respective central region of the slits 20a′, 20b′ and 20c′. Two further cut-outs 53 and 54 are situated between the slits 20a′ and 20b′ and between the slits 20b′ and 20c′, respectively. The cut-out 55 is situated opposite the cut-out 53 on the other side of the slit 20a′. The cut-out 56 is situated opposite the cut-out 54 on the other side of the slit 20c′. The ferrite layers 40 and 41 and the plate 13′ in this case additionally act as cooling elements for dissipating loss heat from electronic components of the device 10′ to the environment.

In conformity with the relevant application, the embodiment shown in FIG. 4 can be modified in such a manner that only one layer of a magnetic material is used. Analogously, the cut-outs 50 to 56 in the printed circuit board 13′, traversed by a magnetic material, are also optional and not required for all feasible applications.

FIG. 6 shows a further embodiment A device 60 comprises a printed circuit board 61 with circuit components on the upper side and the lower side; components 62 are shown, by way of example, on the lower side and components 63 on the upper side, the components 63 (being in particular the switching transistors used in the case of switched converters as shown in FIG. 3) producing such a large amount of loss heat that cooling by dissipation of heat to the ambient atmosphere per se is not adequate, so that additional cooling is required. This additional cooling is provided by a cooling arrangement 64 which consists of one or more layers of a suitably thermally conductive material which is in this case bonded to the printed circuit board 61 by way of a prepeg bond. The reference numeral 65 denotes the prepeg layer used. The reference numeral 66 denotes an adhesive which fills clearances between the cooling arrangement 64 and the printed circuit board 61 with the prepeg layer 65 and the components 63. The cooling arrangement 64 in the embodiment shown in FIG. 6 consists of two layers of ferrite 67 and 68 wherebetween there is arranged a suitably electrically conductive plate 69 which is provided with a structure of slits, has an inductive function and is built like the plate 13′ of FIG. 5.

In a further version of the embodiment of FIG. 6 (not shown) a printed circuit board arrangement with components to be cooled is arranged not only on the lower side of the cooling arrangement 64 but also on the oppositely situated (upper) side of the cooling arrangement 64.

In the further version of an electrically conductive plate 70 in accordance with the invention which is shown in FIG. 7 and is constructed notably as a metal plate, there are provided two spiral-shaped slits 71 and 72 which constitute two corresponding spiral-shaped coil windings which have the same winding orientation in this case, but opposed winding orientations are also feasible. The coil winding formed by the slit 71 is provided with a contact point 73 in its central region and with a further contact point 74 in the region between the central region and the outer segment of the slit 71, which further contact point is provided for an additional tapping. The coil winding formed by the slit 72 is provided with a contact point 75 in its central region and with a further contact point 76 in the region between the central region and the outer segment of the slit 72; this contact point is also provided for an additional tapping. Like in the preceding examples, further contact points 77 are provided adjacent the coil windings formed by the slits 71 and 72. Further possibilities for the realization of inductances are created by way of further contact points serving for tapping.

FIG. 8 shows a further version of an electrically conductive plate 80 in accordance with the invention which comprises two spiral-shaped slits 81 and 82 for forming coil windings which have an opposed winding orientation in this case, but winding orientations in the same direction are also feasible. Contact points are provided only in the two central regions of the slits 81 and 82, that is, the slit 81 comprises a central contact point 83 and the slit 82 comprises a central contact point 84. The number of contact points is thus reduced to a minimum.

1. A device which comprises a circuit arrangement and an electrically conductive plate having an inductive function, which inductive function corresponds to a structure of slits formed in the plate.

2. A device as claimed in claim 1, characterized in that the structure of slits is formed by one or more spiral-shaped slits.

3. A device as claimed in claim 2, characterized in that the spiral-shaped slits are provided with a respective contact point in their central region and/or that at least one further contact point is arranged adjacent the spiral-shaped slits and/or between the central region and the periphery of a spiral-shaped slit.

4. A device as claimed in claim 3, characterized in that there is provided a printed circuit board which supports the circuit arrangement and is electrically coupled to the electrically conductive plate by way of the contact points.

5. A device as claimed in claim 4, characterized in that the printed circuit board supports the electrically conductive plate.

6. A device as claimed in one of the claims 1 to 5, characterized in that the electrically conductive plate has the function of a plurality of coils, the number of which corresponds to the number of spiral-shaped slits.

7. A device as claimed in one of the claims 1 to 6, characterized in that the electrically conductive plate is formed as a sheet of metal.

8. A device as claimed in claim 7, characterized in that an insulating layer is provided between the printed circuit board and the electrically conductive plate.

9. A device as claimed in one of the claims 1 to 8, characterized in that a layer of a magnetic material, notably a ferrite material, is provided on at least one side of the electrically conductive plate.

10. A device as claimed in claim 9, characterized in that there is provided an arrangement which comprises two layers of a magnetic material wherebetween the electrically conductive plate is arranged, on one outer side of the arrangement there being provided a printed circuit board which is electrically coupled to the electrically conductive plate.

11. A device as claimed in one of the claims 4 to 10, characterized in that there is provided a cooling layer which consists of a suitably thermally conductive material, notably metal, and that components of the device which are to be cooled are arranged between the cooling layer and the printed circuit board.

12. A device as claimed in one of the claims 4 to 10, characterized in that either the electrically conductive plate or the layer of a magnetic material is used for cooling.

13. A power supply device which includes a device as claimed in one of the claims 1 to 12.

14. A power supply device as claimed in claim 13, characterized in that the electrically conductive plate serves to form inductances of a multi-phase converter.

15. An electrically conductive plate having an inductive function, the inductive function corresponding to a structure of slits formed in the plate.

16. An electrically conductive plate as claimed in claim 15, characterized in that the structure of slits is formed by spiral-shaped slits.
